(19) United States
(12) Patent Application Publication
(10) Pub. No.: US 2015/0147975 A1
(43) Pub. Date: May 28, 2015

(54) WEARABLE PROJECTION DEVICE

(71) Applicant: Pekall, LLC, San Diego, CA (US)

(72) Inventor: Zhan Li, San Diego, CA (US)

(21) Appl. No.: 14/549,093

(22) Filed: Nov. 20, 2014

(30) Foreign Application Priority Data
Nov. 22, 2013 (CN) 201310590634.2

(51) Int. Cl. H04M 1/57; G03B 21/20; H04L 12/18; H04W 4/00; H04M 11/02

(52) U.S. Cl. CPC H04M 1/576; H04W 4/008; H04M 11/02; H04L 12/1813; G03B 21/2093
USPC 455/41.3

(57) ABSTRACT

Disclosed herein is a method of wireless communication. Displayable information is received on a micro-display communication device from a mobile device. The displayable information may be related to an incoming call, an incoming multimedia message or a notification from an application. A proximate carrier is detected for hosting a projection. The displayable information is projected onto the proximate carrier. The micro-display communication device receives a command from a user in response to the displayable information on the proximate carrier. The command is an acceptance or a rejection. The micro-display communication device transmits the command to the mobile device. When the command is the acceptance, the incoming call, the multimedia message or the notification from the mobile device is transferred to the micro-display communication device. The micro-display communication device is a wearable device.

### CROSS REFERENCE TO RELATED APPLICATIONS

This patent application claims priority from Chinese Patent Application No. 201310590634.2 filed on Nov. 22, 2013, which is incorporated herein by reference.

### BACKGROUND

A communication system is a general term referring to a technology system to complete the information transmission process. Modern communication systems are accomplished mainly through the propagation of electromagnetic wave in the free space or in the guided media; the former communication system is called a wireless communication system, while the other is known as a wire communication system. Mobile terminal, also called mobile communication terminal refers to a computer equipment in motion, which generally includes mobile phones, laptops, POS machines and vehicle computers. As the bandwidth of networks and technologies becomes wider and wider, the mobile communications industry therefore enters into a true information era. On the other hand, with the fast development of integrated circuit technology, processing capabilities of the mobile terminal is very powerful. The mobile terminal has turned from a simple phone call handling tool into a comprehensive information platform. This also broadens the mobile terminal development space.

Currently, some mobile phones in the market have an integrated projector function. Mobile phones with an integrated projector function integrate with micro projection based on Liquid Crystal on Silicon (LCOS) or Digital Light Processing (DLP) technology, and attempt to meet consumer portability, entertainment and practical needs. Because micro projection technology has been developed for several years, the technology is relatively mature and stable. Mobile phones with an integrated projector feature generally have the same appearance as mobile phones without this feature.

However, in the existing technology, if the mobile phone is integrated with a projector module, after relatively long hours of projection, it will adversely affect the normal phone operation due to the accumulated heat generated during the projection process. In addition, the mobile phone with a projector module with existing technology provides one-way projection output.

### SUMMARY

Disclosed herein is a method of wireless communication. Displayable information is received on a micro-display communication device from a mobile device. The displayable information may be related to an incoming call, an incoming multimedia message or a notification from an application. A proximate carrier is detected for hosting a projection. The displayable information is projected onto the proximate carrier. The micro-display communication device receives a command from a user in response to the displayable information on the proximate carrier. The command is an acceptance or a rejection. The micro-display communication device transmits the command to the mobile device. When the command is the acceptance, the incoming call, the multimedia message or the notification from the mobile device is transferred to the micro-display communication device. The micro-display communication device is a wearable device.

The present invention is better understood upon consideration of the detailed description below in conjunction with the accompanying drawings and claims.

### BRIEF DESCRIPTION OF DRAWINGS

FIG. 1 depicts the network environment of an exemplary communication system;

FIGS. 2-3 show an example embodiments of the micro-display communication device;

FIGS. 4A-4C illustrate a block diagram for an example embodiment for a method of wireless communication;

FIGS. 5A-5C show example embodiments for a method of projection;

FIG. 6 is an example embodiment for a flowchart for a method of communication;

FIG. 7 is an example embodiment of the micro-display communication device;

FIGS. 8A-8C show an example embodiment of the displayable information;

FIG. 9 depicts an example embodiment of a command by hand gesture;

FIG. 10 depicts an example embodiment of the earbud and microphone device of the micro-display communication device; and

FIGS. 11A-11C show the earbud and microphone device stored within the micro-display communication device.

### DETAILED DESCRIPTION

The embodiments of the present invention provide a method of wireless communication, a micro-display communication device and a micro-display communication system for communication to achieve projection by a micro-display communication device of mobile device related contents. For the method of wireless communication, displayable information is received on a micro-display communication device from a mobile device. The displayable information may be related to an incoming call, an incoming multimedia message or a notification from an application. A proximate carrier is detected for hosting a projection. The displayable information is projected onto the proximate carrier. The micro-display communication device receives a command from a user in response to the displayable information on the proximate carrier. The command is an acceptance or a rejection. The micro-display communication device transmits the command to the mobile device. When the command is the acceptance, the incoming call, the multimedia message or the notification from the mobile device is transferred to the micro-display communication device. The micro-display communication device is a wearable device.

The device is a wireless, micro-display communication device. A communication module receives displayable information from a mobile device. The displayable information is related to an incoming call, an incoming multimedia message or a notification from an application. A detection module detects a proximate carrier for hosting a projection. A projection module projects the displayable information onto the proximate carrier. A control module receives a command in response to the displayable information on the proximate carrier. The command is an acceptance or a rejection. A transmission module transmits the command to the mobile device. When the command is the acceptance, the communication module receives the incoming call, the multimedia message or the notification from the mobile device. The micro-display communication device is a wearable device.

The system is a wireless, micro-display communication system. A mobile device transmits displayable information. A micro-display communication device receives the displayable information from a mobile device. The displayable information is related to an incoming call, an incoming multimedia message or a notification from an application. A proximate carrier is detected for hosting a projection. The displayable information is projected onto the proximate carrier. The micro-display communication device receives a command from a user in response to the displayable information on the proximate carrier. The command is an acceptance or a rejection. The micro-display communication device transmits the command to the mobile device. When the command is the acceptance, the incoming call, the multimedia message or the notification is transferred from the mobile device to the micro-display communication device. The micro-display communication device is a wearable device.

The micro-display communication device may be a pendant, necklace, earring, bracelet, watch, belt, eye glasses or other wearable device. The pendant may be made from zirconia ceramic or other materials.

In one embodiment, the displayable information for the incoming call or the multimedia message may include an incoming number and a contact name associated with the incoming number. The incoming number and contact name may be a saved contact on the mobile device. In another embodiment, the displayable information for the notification may include a message from a social media site and an identification of the social media site associated with the message. The social media site may be a saved application on the mobile device.

The method of wireless communication and the micro-display communication system of wireless communication may further comprise an earbud and microphone device for wireless communication for the incoming call. The earbud and microphone device may be capable of being stored within the micro-display communication device and may be removable from the micro-display communication device.

In one embodiment, the command may be a hand gesture. The hand gesture may interrupt a light beam from the micro-display communication device and a pattern of interruptions to the light beam matches a pre-programmed pattern for determining the command.

In other embodiments, the micro-display communication device may detect the proximate carrier when the proximate carrier is located approximately 5-20 centimeters from the micro-display communication device. The micro-display communication device may project the displayable information onto the proximate carrier when the proximate carrier is located approximately 5-20 centimeters from the micro-display communication device.

The wireless communication may utilize Bluetooth or Infrared technology.

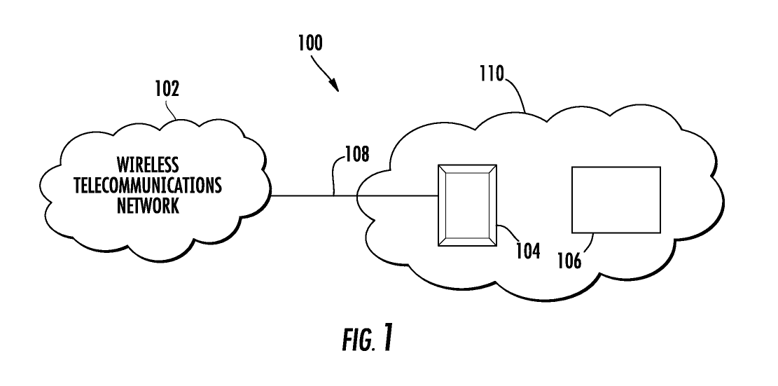

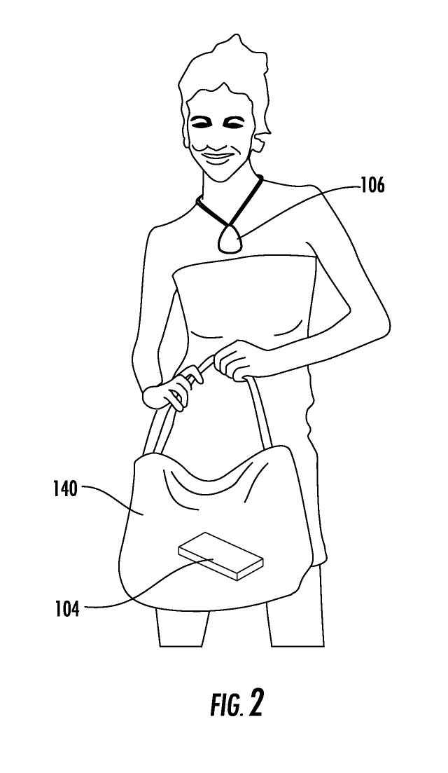

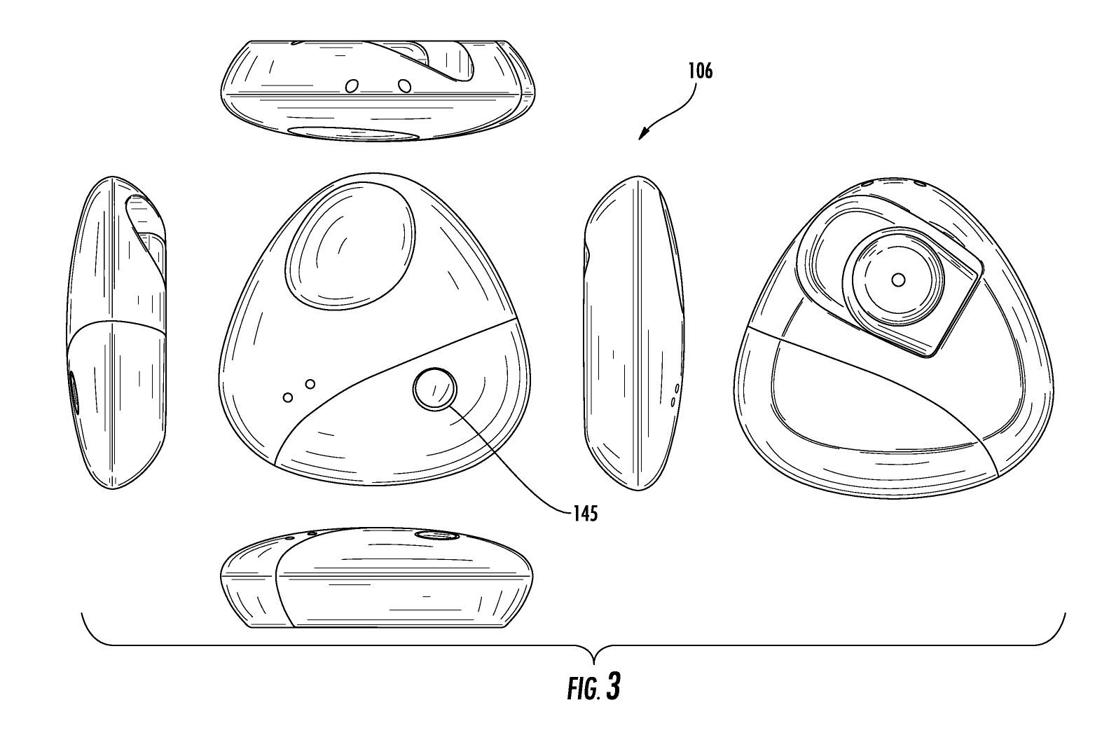

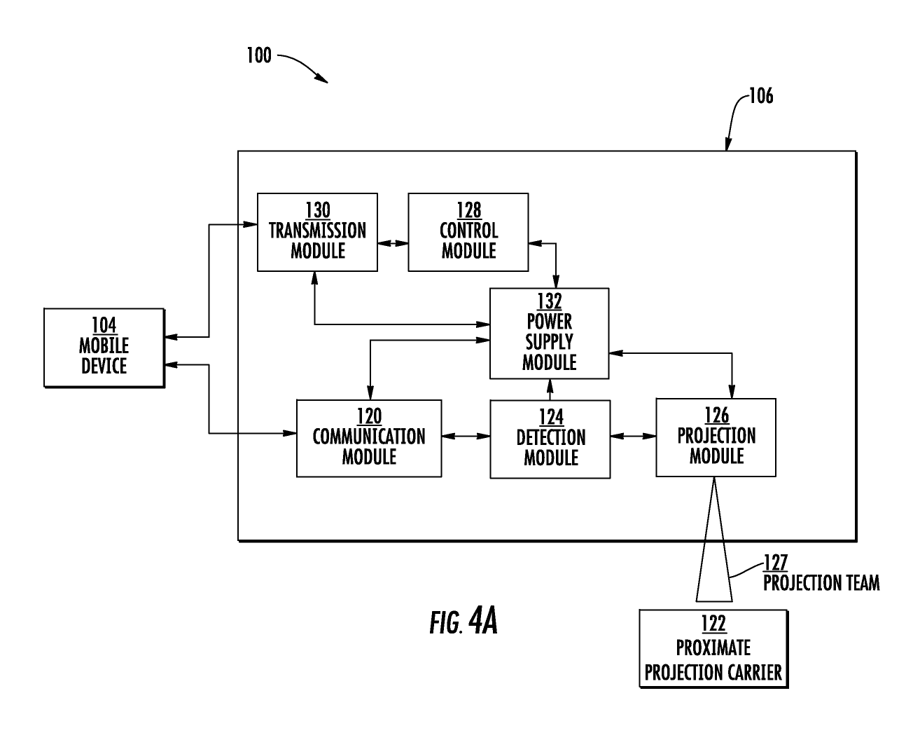

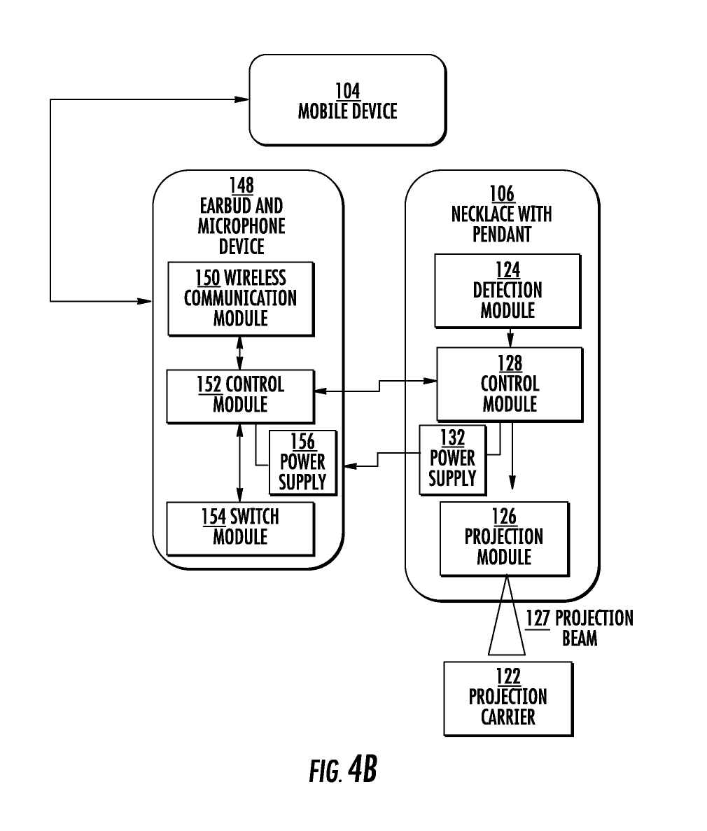

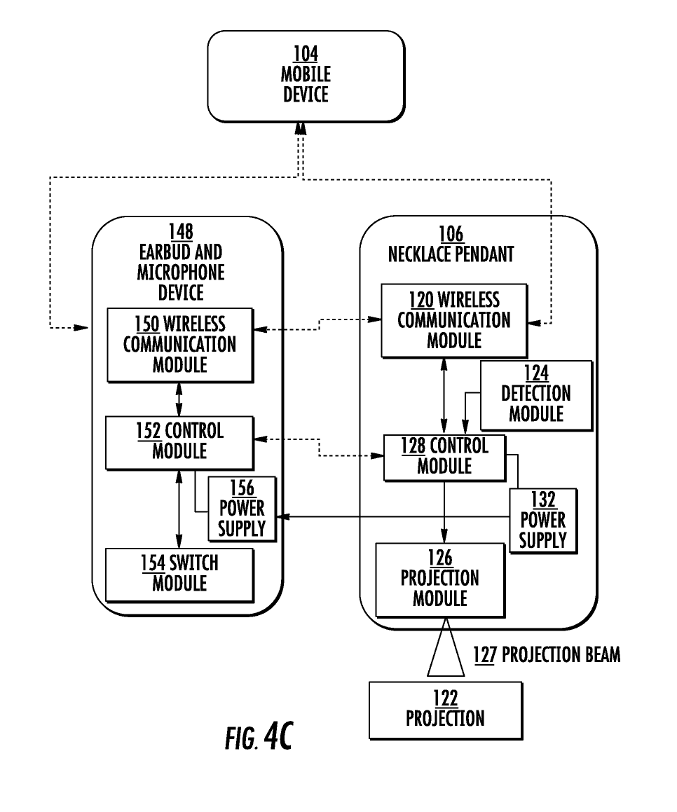

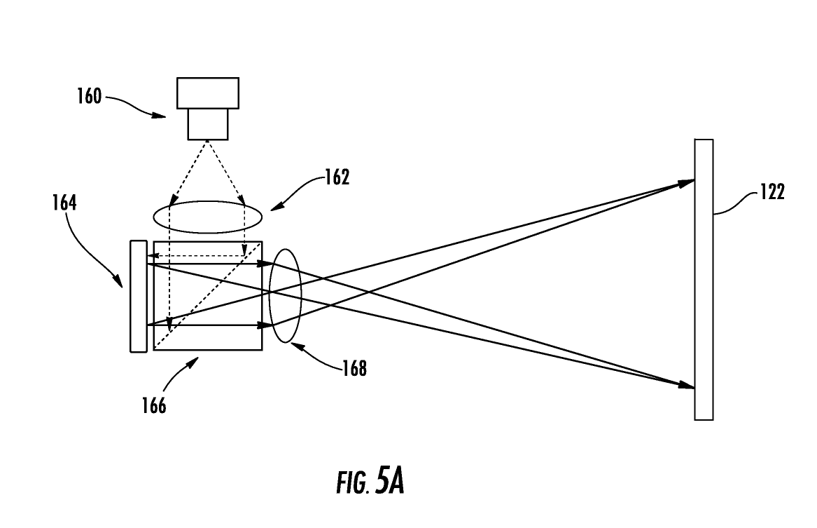

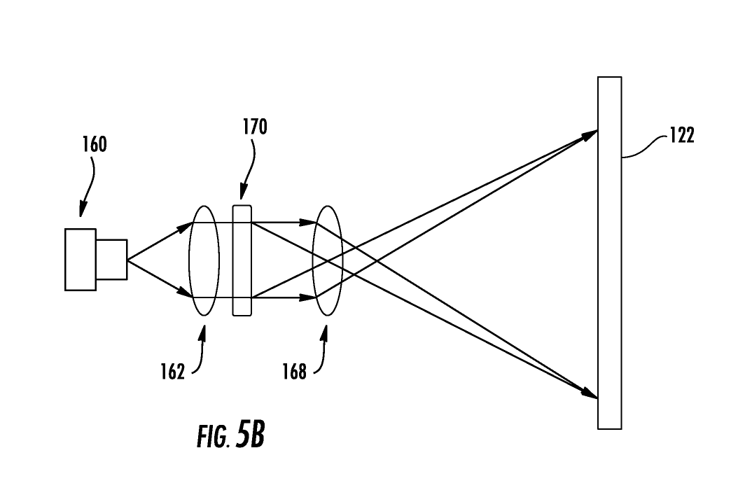

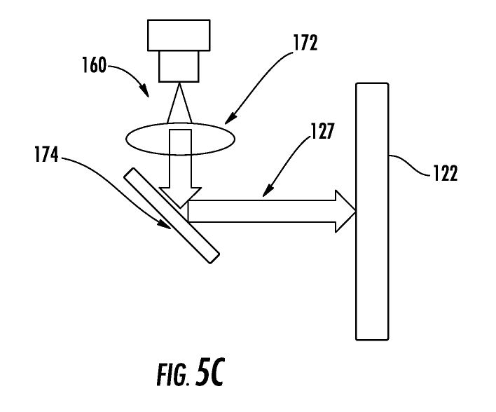

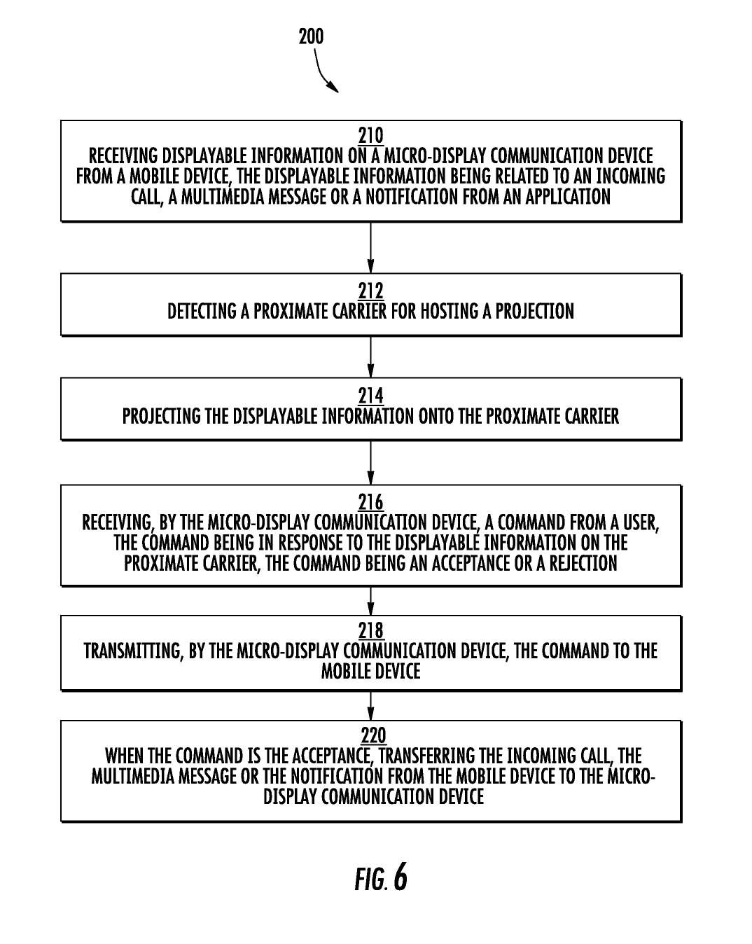

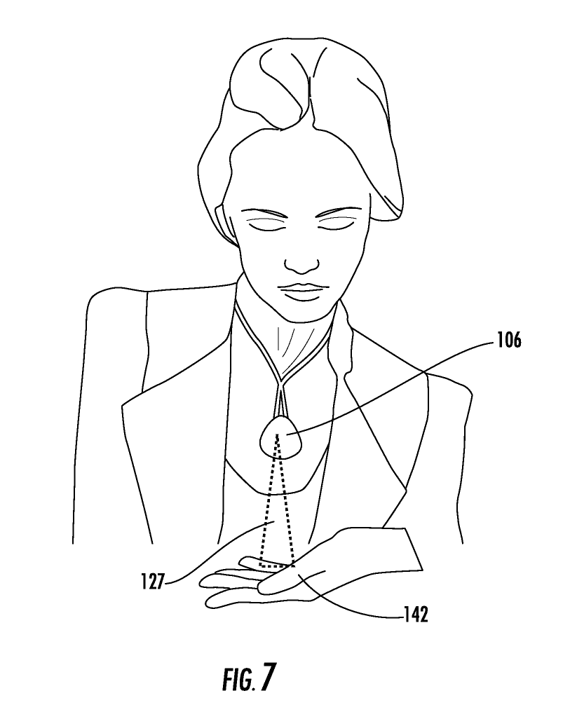

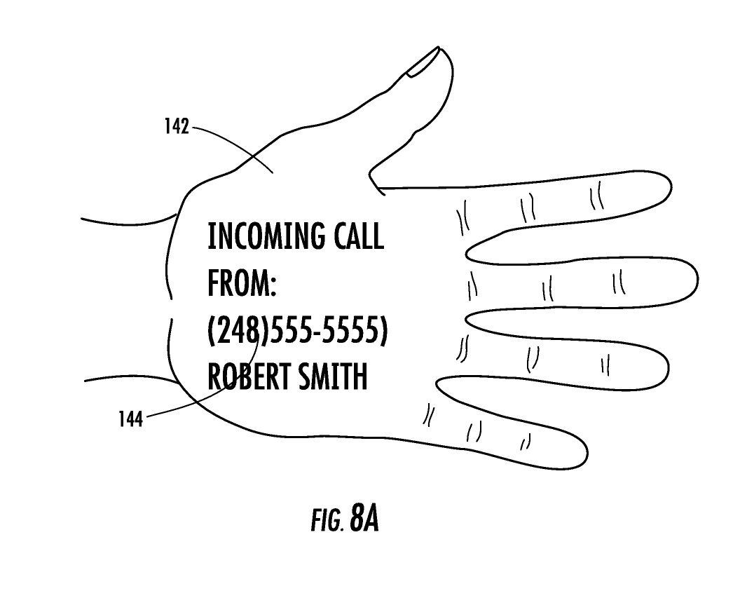

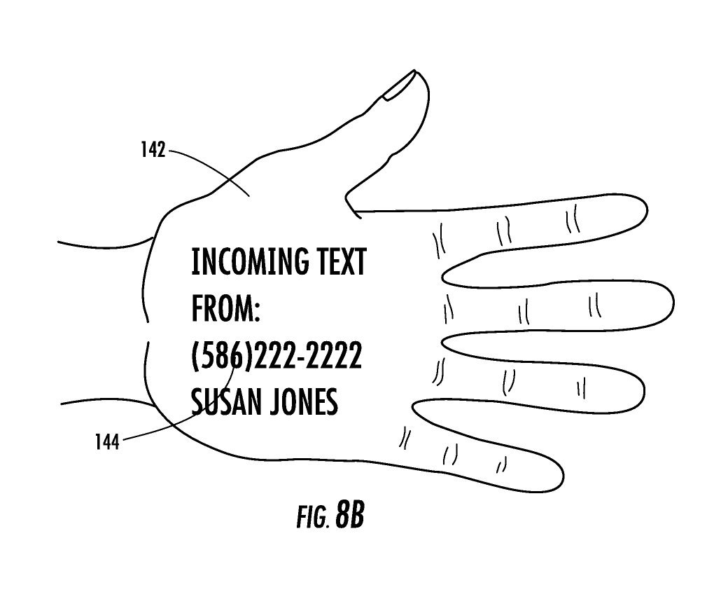

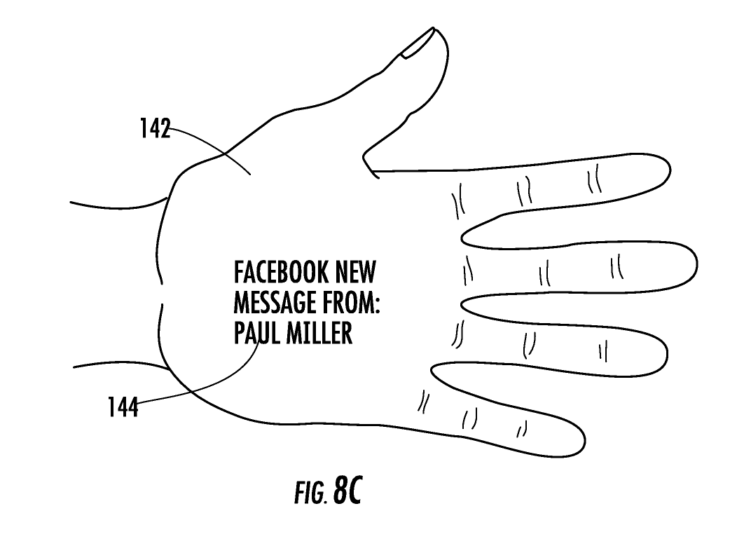

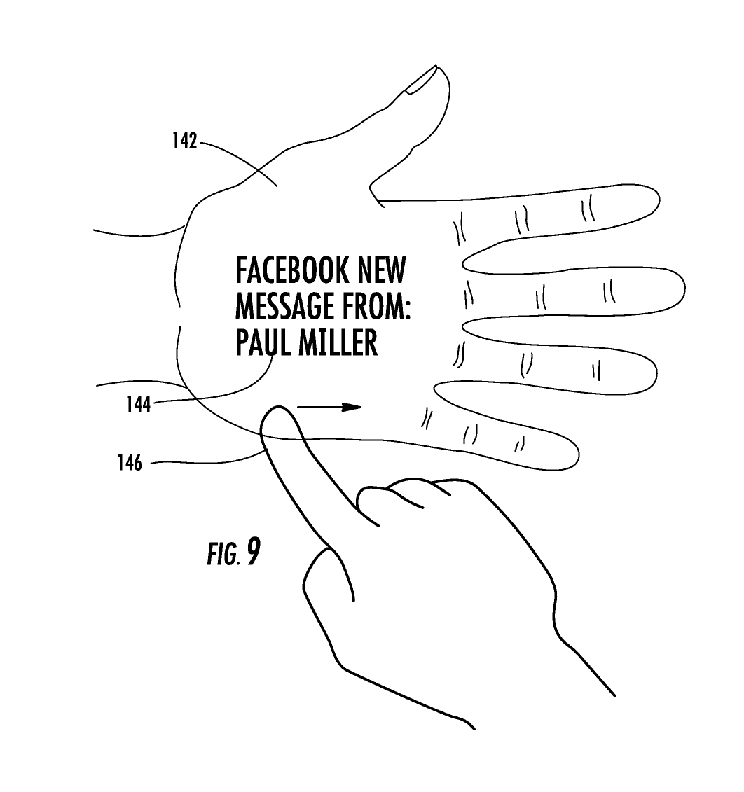

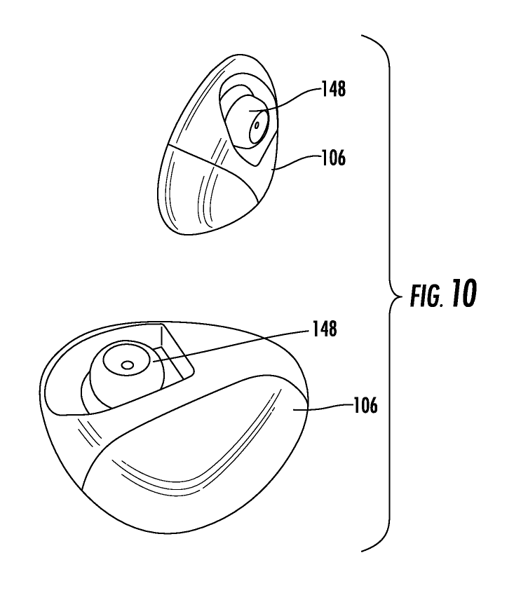

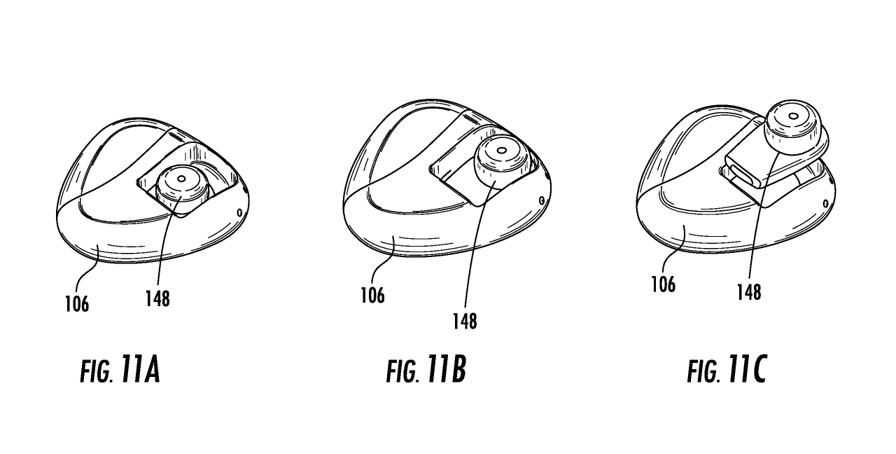

FIG. 1 depicts the network environment of an exemplary communication system 100 in which exemplary embodiments of the present invention may be employed. The communication system 100 may include a wireless telecommunications network 102, a wireless mobile device 104 and a micro-display communication device 106. By employing the communication system 100, the micro-display communication device 106, may project displayable information from for the wireless mobile device 104.

The wireless mobile device 104 may generally be any type of device for communicating via a wireless telecommunications network, such as the wireless telecommunications network 102. By way of example only and not limitation, the telecommunications device 104 may be a smartphone, cellphone, mobile phone, laptop, tablet, personal digital assistant, personal computer, or smart TV. The wireless mobile device 104 may communicate with the wireless telecommunications network 102 over a long-range radio frequency (RF) interface 108. The wireless mobile device 104 may both transmit and receive RF signals over the long-range RF interface 108. The communication may occur in a digital format, such as CDMA, TDMA, GSM, or may occur in an analog format, such as AMPS.

The wireless mobile device 104 may be capable of receiving displayable information from the wireless telecommunications network 102. By way of example only and not limitation, the displayable information may be requests for incoming network events including incoming calls, short message service (SMS) messages, text messages, multimedia messages, notifications from an application, alerts, game events, instant messages, chat messages, calendar details, song lyrics, push-to-talk messages, downloads, emails and voicemail. These requests may consist of text, audio, or video signals, or a combination thereof. In embodiments of the invention, the micro-display communication device 106, may communicate with the wireless mobile device 104 and project the displayable information from the wireless mobile device 104. The wireless mobile device 104 and micro-display communication device 106 may communicate via a wireless personal area network (PAN) 110. In other embodiments, the network may be a wireless network such as WiFi or cellular networks based on an ISM band (e.g., 433 MHz). The wireless PAN 110 may allow communication via a short-range RF interface. The communication may comply with Bluetooth, ZigBee, or other standards for short-range wireless communications. Infrared (IR) data transmission may also be used.

The micro-display communication device 106 may be a wearable device, such as an accessory item. For instance, the micro-display communication device 106 may be a pendant, necklace, earring, bracelet, watch, belt or eye glasses. A user may wear such device on, for example, the hand, wrist, foot, ear, nose, waist, head or any other part of the body. FIGS. 2 and 3 show an example embodiments of the micro-display communication device 106. In FIG. 2, the micro-display communication device 106 is depicted as a pendant on a necklace. In FIG. 3, the pendant as the micro-display communication device 106 is illustrated in several views.

In one embodiment, the micro-display communication device 106, such as the pendant, may be a small, compact design of approximately 4.8 centimeters by 4.8 centimeters by 1.5 centimeters or smaller. In further embodiments, other sizes may be used depending on the particular wearable device. It may be made from a ceramic material such as zirconia. Other materials may be used such as composites, plastics, rubber, metals or metals with a ceramic surface treatment.

The micro-display communication device 106 is wireless. A communication module receives displayable information from a mobile device 104. The displayable information is related to an incoming call, an incoming multimedia message or a notification from an application. A detection module detects a proximate carrier for hosting a projection. A projection module projects the displayable information onto the proximate carrier. A control module of the micro-display communication device 106 receives a command in response to the displayable information on the proximate carrier. The command is an acceptance or a rejection. A transmission module of the micro-display communication device 106 transmits the command to the mobile device 104. When the command is the acceptance, the communication module receives the incoming call, the multimedia message or the notification from the mobile device 104 to the micro-display communication device 106. The micro-display communication device 106 is a wearable device.

FIG. 4A illustrates a block diagram for an example embodiment for a method of wireless communication. A communication module 120 of the micro-display communication device 106 receives displayable information from a mobile device 104 located within the PAN 110. In one embodiment, the displayable information may be related to an incoming call, an incoming multimedia message or a notification from an application. A user may be alerted to the request by a sound, vibration or pulse of light by the micro-display communication device 106. The user may then position a proximate carrier 122 approximately 5-20 centimeters, 10-20 centimeters or 15-20 centimeters from the micro-display communication device 106. The proximate carrier 122 may be any nontransparent object, for instance, the hand of the user. The micro-display communication device 106 may detect the proximate carrier 122 when the proximate carrier 122 is located approximately 5-20 centimeters, 10-20 centimeters or 15-20 centimeters from the micro-display communication device 106. For example, a detection module 124 detects a proximate carrier 122 for hosting a projection when it is positioned approximately 5-20 centimeters from the micro-display communication device 106. This detection may be by a sensor or a camera.

The micro-display communication device 106 may project the displayable information onto the proximate carrier 122 when the proximate carrier is located approximately 5-20 centimeters from the micro-display communication device 106 only after a proximate carrier 122 is detected. In this way, the user controls whether or not the displayable information will be projected. For example, a projection module 126 projects the displayable information onto the proximate carrier 122 by a projection beam 127 for the user to peruse. The projection continues as long as the proximate carrier 122 is positioned approximately 5-20 centimeters from the micro-display communication device 106. If the proximate carrier 122 is no longer detected, the projection ends. In another embodiment, the time length of projection may be programmed such as for 5 seconds, 10 seconds or 1 minute.

The projected beam 127 may be from a laser. In another embodiment, the projected beam 127 may be from an LED. Direct projection is used after the detection module 124 detects a proximate carrier 122 for hosting a projection when it is positioned approximately 5-20 centimeters from the micro-display communication device 106. This allows the laser to be in a small, controlled area having a focal point and preventing stray beams from the laser spreading out which may cause damage to an eye or to the vision of people in the vicinity.

FIGS. 5A-5C show example embodiments for a method of projection. In FIG. 5A, a laser 160 emits a beam onto a convex lens 162. A reflective LCD 164, such as liquid crystal on silicon (LCOS), is used with a polarization beam splitter 166 to send the laser beam through a projection lens 168 then onto the proximate carrier 122. In FIG. 5B, a laser 160 emits a beam onto a convex lens 162 then through a transmission LCD 170 and through a projection lens 168 onto the proximate carrier 122. In FIG. 5C, a laser 160 emits a beam onto a collimating lens 172 to produce a parallel laser beam. An electrostatic drive MEMS (Micro-Electro-Mechanical Systems) reflective scanner 174 is used to reflect and scan the beam, and then the projected beam 127 is projected onto the proximate carrier 122.

In response to the contents of the displayable information, the user may decide to accept or reject the request by way of a command. A control module 128 of the micro-display communication device 106 receives the command from the user, the command being in response to the displayable information on the proximate carrier 122 while the user is reading the displayable information on the proximate carrier 122. The command signifies an acceptance or a rejection. In one embodiment, the command is a hand gesture. In other embodiments, the command may be a voice or sound pattern, or may be a mechanism. The control module 128 may use a gesture recognition module, a voice/sound recognition module or a mechanism recognition module to decipher the command.

When the control module 128 uses a gesture recognition module, it consists of a motion-capture module and a sub-control module in the micro-display communication device 106. A gesture, such as a finger swipe from left to right in a certain pattern, may be detected by the motion capture module, then sent to the sub-control module. The sub-control module analyzes the gesture and compares it to a database of programmed gestures. The programmed gestures have instructions associated with the gesture. For example, a particular gesture may be associated with an instruction to answer an incoming call, music playback, or forwarding the contents of a text message. The sub-control module then matches the particular gesture to one of the programmed gestures with associated instructions. The instructions are transmitted to the communication module 120 of the micro-display communication device 106 then transmitted to the mobile device 104. The mobile device 104 then performs the instruction.

The control module 128 may also use voice/sound recognition operating in a similar way as the gesture recognition described herein. However, the voice/sound is compared to a database of programmed voice/sounds with associated instructions. The control module 128 may also use mechanism recognition consisting of a mechanism module and a sub-control module in the micro-display communication device 106. When a mechanical switch on the micro-display communication device is pushed by the user, instructions corresponding to the mechanic switch are generated in the sub-control module and transmitted to the communication module 120 of the micro-display communication device 106. The instructions are further sent to the mobile device 104. The mobile device 104 then performs the instructions.

The hand gesture may interrupt the projection beam 127 from the micro-display communication device 106 and a pattern of interruptions to the projection beam 127 may match a pre-programmed pattern for determining the command. For example, the command for an acceptance may be tapping a finger against the proximate carrier 122 once. Likewise, the command for the rejection may be tapping a finger against the proximate carrier 122 twice. In another example, the command an acceptance may be swiping a hand or a finger from left to right on the proximate carrier 122, whereas the command the rejection may be swiping a hand or a finger in an upward direction on the proximate carrier 122. In another example, the command for an acceptance may be moving the proximate carrier 122 toward the micro-display communication device 106. Similarly, the command for a rejection may be moving the proximate carrier 122 away from the micro-display communication device 106.

The control module 128 of the micro-display communication device 106 receives the command from the user, the command being in response to the displayable information on the proximate carrier 122 while the user is perusing the displayable information on the proximate carrier 122. The command signifies an acceptance or a rejection based on pre-programmed logic. For example, the displayable information may be controlled in response to the command of a user which results in more interactive control.

A transmission module 130 of the micro-display communication device 106 transmits the command to the mobile device 104. A power supply module 132 is used to provide the power for the other modules of the micro-display communication device 106. The power supply module 132 may include a battery, charging circuit or wireless charging module which may be a wireless charging coil, a wireless charging circuit and a control unit.

When the command is a rejection, the mobile device 104 responds accordingly. For example, if the displayable information is related to an incoming call, the incoming call will be sent to the voicemail function. In another example, if the displayable information is related to a multimedia message or a notification from an application, the request will be ignored.

When the command is an acceptance, the mobile device 104 responds accordingly. For example, if the displayable information is related to an incoming call, the communication module 120 on the micro-display communication device 106 receives the incoming call from the mobile device 104. In another example, if the displayable information is related to a multimedia message or a notification from an application, the communication module 120 on the micro-display communication device 106 receives the complete multimedia message or the complete notification and projects this on the proximate carrier 122.

In one embodiment, for instance, upon receiving an incoming call from the wireless telecommunications network 102, the mobile device 104 receives the external signal and transmits the external signal to the communication module 120 of the micro-display communication device 106. This external signal is then passed to the projection module 126 and the information contained in the external signal may be projected. The information projected may be the incoming number and also the contact name associated with the incoming number. After the user reviews the projected information (incoming number and contact name), the user may accept the incoming call, or the user may reject the incoming call by a command through the control module 128 of the micro-display communication device 106.

FIG. 4B illustrates a block diagram for an example embodiment for a method of wireless communication. An earbud and microphone device 148 may be coupled to the micro-display communication device 106 with a connector for a wired connection. The earbud and microphone device 148 may include a wireless communication module 150, a control module 152 and a switch module 154. When the earbud and microphone device 148 is decoupled from the micro-display communication device 106, the wireless communication module 150 enables direct communication with the mobile device 104. In this way, when the incoming call is transferred to the micro-display communication device 106 by the mobile device 104, the user may remove the earbud and microphone device 148 from the micro-display communication device 106, position it into the ear, and, for example by Bluetooth technology, the user may answer and converse with the incoming call.

In this mode, information may be transmitted directly from the mobile device 104 to the earbud and microphone device 148. Information may be transmitted from the mobile device 104 to the micro-display communication device 106 when the earbud and microphone device 148 is coupled to the micro-display communication device 106, such as by plugging the connector of the earbud and microphone device 148 back into the micro-display communication device 106.

In one embodiment, the earbud and microphone device 148 may also include a power supply 156. The power supply 156 may be recharged by the power supply module 132 in the micro-display communication device 106.

FIG. 4C illustrates a block diagram for an example embodiment for a method of wireless communication. An earbud and microphone device 148 may be coupled to the micro-display communication device 106 with a wireless connection. This may be by Bluetooth, WiFi, Zigbee or ISM band. In this mode, information may be transmitted from the mobile device 104 to the micro-display communication device 106 or from the earbud and microphone device 148 to the micro-display communication device 106. In this case, the micro-display communication device 106 may always receive information.

FIG. 6 is an example embodiment for a flowchart for a method of communication 200. At step 210, displayable information is received on a micro-display communication device from a mobile device. The displayable information may be related to an incoming call, a multimedia message or a notification from an application. At step 212, a proximate carrier is detected for hosting a projection, and at step 214, the displayable information is projected onto the proximate carrier. At step 216, the micro-display communication device receives a command from a user in response to the displayable information on the proximate carrier. The command is an acceptance or a rejection. At step 218, the micro-display communication device transmits the command to the mobile device. At step 220, when the command is the acceptance, the incoming call, the multimedia message or the notification from the mobile device is transferred to the micro-display communication device. The micro-display communication device is a wearable device.

In an example implementation, the user is wearing the micro-display communication device 106 as a pendant on a necklace as shown in FIG. 2. The user also has a mobile device 104 such as a smartphone inside of a handbag 140 which is within the PAN 110 (refer to FIG. 1). Through the wireless telecommunication network 102, as shown in FIG. 1, an incoming call is received by the mobile device 104. Displayable information is received on a micro-display communication device 106 from a mobile device 104. For example, the wireless communication may utilize Bluetooth or Infrared technology. Referring to FIG. 2, the micro-display communication device 106 alerts the user of a request by vibration.

FIG. 7 is an example embodiment of the micro-display communication device 106. Upon the vibration of the micro-display communication device 106, the user may choose to position a hand 142 approximately 5-20 centimeters from the micro-display communication device 106. The hand 142 is detected by the micro-display communication device 106 and displayable information 144 is projected from a projection lens 145 (as shown in FIG. 3) on the micro-display communication device 106 onto the hand 142 of the user for the user to read. In this way, the user does not need the actual mobile device 104 to determine what the request is because the micro-display communication device 106 projects the displayable information 144 for the user. The displayable information 144 is only projected after detecting the proximate carrier 122 (e.g., the hand 142). This is also hands free.

FIG. 8A shows an example embodiment of the displayable information. In one embodiment, the displayable information 144 for the incoming call or the multimedia message may include an incoming number and a contact name associated with the incoming number. The incoming number and contact name may be a saved contact on the mobile device 104. When the mobile device 104 receives an incoming call from the wireless telecommunication network 102, the mobile device 104 synchronizes the incoming number with the contact name of a saved contact on the mobile device 104. This synchronized information becomes the displayable information 144 for the micro-display communication device 106. For example, the displayable information 144 displays:

Incoming call from:

(248) 555-5555

Robert Smith

Similarly, FIG. 8B shows another example embodiment of the displayable information 144. The displayable information 144 for the multimedia message includes an incoming number and a contact name associated with the incoming number. The incoming number and contact name are a saved contact on the mobile device 104. For example, the displayable information 144 displays:

Incoming text from:

(586) 222-2222

Susan Jones

In another embodiment, if the incoming number is not a saved contact on the mobile device 104, the displayable information 144 displays “unknown” as the incoming number and contact name. In yet another embodiment, if the incoming number is not a saved contact on the mobile device 104, the displayable information 144 displays the incoming number and “unknown” as the contact name.

In a further embodiment, the displayable information 144 for the multimedia message includes an incoming number, a contact name associated with the incoming number and the complete message. This may be accomplished by slowly and continuously scrolling the text line by line.

FIG. 8C shows a further example embodiment of the displayable information 144. The displayable information 144 for the notification may include a message from a social media site and an identification of the social media site associated with the message. The social media site is a saved application on the mobile device 104. For example, the displayable information 144 displays:

Facebook new message from:

Paul Miller

The user may decide to accept or reject the request by way of a command which may be a hand gesture. The command is received by the micro-display communication device 106 and is in response to the displayable information 144 on the proximate carrier 122. The command by hand gesture may be performed while the user is perusing the displayable information 144 on the hand 142. FIG. 9 depicts an example embodiment of a command by hand gesture. In this embodiment, the command to allow the request is accomplished by swiping a hand or a finger 146 across the displayable information 144 from left to right. The command is transmitted by the micro-display communication device 106 to the mobile device 104. The mobile device 104 responds accordingly, for example, by transmitting the incoming call to the micro-display communication device 106.

The method of wireless communication, the micro-display communication device 106 and the micro-display communication system may further comprise an earbud and microphone device 148 for wireless communication for the incoming call. Referring to FIGS. 4A-4C, the communication module 120 may receive the audio signal content related to an audio file transmitted from the mobile device 104 after the mobile device 104 has decoded the audio file. The audio signal may be sent to the earbud and microphone device 148 and the audio signal may be converted into sound.

FIG. 10 depicts an example embodiment of the earbud and microphone device 148 of the micro-display communication device 106. The earbud and microphone device 148 may be capable of being stored within the micro-display communication device 106. The earbud and microphone device 148 may also be removable from the micro-display communication device 106. FIGS. 11A, 11B and 11C show the earbud and microphone device 148 stored within the micro-display communication device 106 and removed from the micro-display communication device 106. This may be accomplished by sliding the earbud and microphone device 148 into a compartment on the micro-display communication device 106. In other embodiments, the earbud and microphone device 148 may be fastened to the micro-display communication device 106 by other means such as a snap fit design, notch/groove design, fasteners, or magnetic forces. This is a simple, fast and convenient way to access or detach the earbud and microphone device 148.

When the incoming call is transferred to the micro-display communication device 106 by the mobile device 104, the user may remove the earbud and microphone device 148 from the micro-display communication device 106, position it into the ear, and, for example, by Bluetooth technology, the user may answer and converse with the incoming call. When the user is finished with the incoming call, the earbud and microphone device 148 may be removed from the ear of the user and placed into the micro-display communication device 106 for storage. The earbud and microphone device 148 device may be used to respond to other displayable information for incoming network events such as short message service (SMS) messages, text messages, multimedia messages, notifications from an application, alerts, game events, instant messages, chat messages, calendar details, song lyrics, music, push-to-talk messages, downloads, emails and voicemail.

When a command for acceptance is transmitted by the micro-display communication device 106 to the mobile device 104, the mobile device 104 may respond accordingly. For example, for an incoming text message, the mobile device 104 may transmit the entire text message to the micro-display communication device 106. Upon occurrence, the entire text message may be projected for the user. This may be accomplished by slowly and continuously scrolling the text line by line. In other embodiments, the user may control the scrolling of the text line by line by a command such as a hand gesture, voice/sound or mechanical mechanism. In one implementation, the length of time of the projection will continue while the micro-display communication device 106 detects the proximate carrier 122 located approximately 5-20 centimeters from the micro-display communication device 106.

The micro-display communication device 106 may be fully integrated into other forms of wearable devices such as a pair of glasses with the projection module 126 integrated into the frame or temple bar. In further embodiments, the micro-display communication device 106 may be fully integrated into a bracelet or a watch with the projection module 126 integrated into the wrist portion of the bracelet or the strap of the watch. These designs enable a fast and convenient way of receiving, reviewing and projecting the request from the mobile device 104.

Referring to FIGS. 4A-4C, the system is a wireless, micro-display communication system. A mobile device 106 transmits displayable information. A micro-display communication device 106 receives the displayable information from a mobile device 104. The displayable information is related to an incoming call, a multimedia message or a notification from an application. A proximate carrier 122 is detected for hosting a projection. The displayable information is projected onto the proximate carrier 122. The micro-display communication device 106 receives a command from a user in response to the displayable information on the proximate carrier 122. The command is an acceptance or a rejection. The micro-display communication device 106 transmits the command to the mobile device 104. When the command is the acceptance, the incoming call, the multimedia message or the notification is transferred from the mobile device to the micro-display communication device 106. The micro-display communication device 106 is a wearable device.

The method of wireless communication, the micro-display communication device 106 and the micro-display communication system described herein have many features. For example, because the earbud and microphone device 148 is concealed in the micro-display communication device 106, there is no need for the user to carry additional devices, such as a Bluetooth headset, to communicate with a mobile device 104. The micro-display communication device 106 is an attractive, stylish fashion accessory that is lightweight and easily portable.

The displayable information 144 is only projected after detecting a proximate carrier 122. In this way, the user controls whether or not the displayable information 144 is projected instead of a system that automatically projects displayable information. With this implementation, the user is thereby ready to receive the displayable information, and the displayable information may be read only by the user keeping the displayable information confidential. This is in contrast to the displayable information being projected at an inappropriate time and possibly being read by other people.

Moreover, the method of communication is hands free because the user may accept or reject requests, for example, for incoming calls, short message service (SMS) messages, text messages, multimedia messages, notifications from an application, alerts, game events, instant messages, chat messages, calendar details, song lyrics, push-to-talk messages, downloads, emails and voicemail, from the mobile device 104 without actual physical operation or touching the mobile device 104. This also eliminates having to locate the mobile device 104 when a request is received. These embodiments may be applied to various existing terminals, and may be cross-platform or cross-terminal.

Furthermore, the mobile device 104 and the projection module 126 of the micro-display communication device 106 are separate units, which avoids the influence of heat, such as overheating, generated during projection so that the device can function properly. This also has power savings benefits and prolongs the duration of operation of the separate devices.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

1. A method of wireless communication, comprising:
receiving displayable information on a micro-display communication device from a mobile device, the displayable information being related to an incoming call, an incoming multimedia message or a notification from an application;
detecting a proximate carrier for hosting a projection;
projecting the displayable information onto the proximate carrier;
receiving, by the micro-display communication device, a command from a user, the command being in response to the displayable information on the proximate carrier, the command being an acceptance or a rejection;
transmitting, by the micro-display communication device, the command to the mobile device; and
when the command is the acceptance, transferring the incoming call, the multimedia message or the notification from the mobile device to the micro-display communication device;
wherein the micro-display communication device is a wearable device.

2. The method of wireless communication of claim 1, wherein the micro-display communication device is a pendant, necklace, earring, bracelet, watch, belt or eye glasses.

3. The method of wireless communication of claim 2, wherein the pendant is made from zirconia ceramic.

4. The method of wireless communication of claim 1, wherein the displayable information for the incoming call or the multimedia message includes an incoming number and a contact name associated with the incoming number, the incoming number and contact name being a saved contact on the mobile device.

5. The method of wireless communication of claim 1, wherein the displayable information for the notification includes a message from a social media site and an identification of the social media site associated with the message, the social media site being a saved application on the mobile device.

6. The method of wireless communication of claim 1, further comprising an earbud and microphone device for wireless communication for the incoming call;
wherein the earbud and microphone device is capable of being stored within the micro-display communication device; and
wherein the earbud and microphone device is removable from the micro-display communication device.

7. The method of wireless communication of claim 1, wherein the command is a hand gesture.

8. The method of wireless communication of claim 7, wherein the hand gesture interrupts a light beam from the micro-display communication device and a pattern of interruptions to the light beam matches a pre-programmed pattern for determining the command.

9. The method of wireless communication of claim 1, wherein the wireless communication utilizes Bluetooth or Infrared technology.

10. The method of wireless communication of claim 1, wherein the micro-display communication device detects the proximate carrier when the proximate carrier is located approximately 5-20 centimeters from the micro-display communication device.

11. The method of wireless communication of claim 1, wherein the micro-display communication device projects the displayable information onto the proximate carrier when the proximate carrier is located approximately 5-20 centimeters from the micro-display communication device.

12. A wireless, micro-display communication device, comprising:
a communication module receiving displayable information from a mobile device, the displayable information being related to an incoming call, an incoming multimedia message or a notification from an application;
a detection module detecting a proximate carrier for hosting a projection;
a projection module projecting the displayable information onto the proximate carrier;
a control module receiving a command from a user, the command being in response to the displayable information on the proximate carrier, the command being an acceptance or a rejection; and
a transmission module transmitting the command to the mobile device;
wherein, when the command is the acceptance, the communication module receives the incoming call, the multimedia message or the notification from the mobile device; and
wherein the micro-display communication device is a wearable device.

13. The communication device of claim 12, wherein the micro-display communication device is a pendant, necklace, earring, bracelet, watch, belt or eye glasses.

14. The communication device of claim 13, wherein the pendant is made from zirconia ceramic.

15. The communication device of claim 12, wherein the displayable information for the incoming call or the multimedia message includes an incoming number and a contact name associated with the incoming number, the incoming number and contact name being a saved contact on the mobile device.

16. The communication device of claim 12, wherein the displayable information for the notification includes a message from a social media site and an identification of the social media site associated with the message, the social media site being a saved application on the mobile device.

17. The communication device of claim 12, further comprising an earbud and microphone device for wireless communication with the incoming call;
wherein the earbud and microphone device is capable of being stored within the micro-display communication device; and
wherein the earbud and microphone device is removable from the micro-display communication device.

18. The method of wireless communication of claim 12, wherein the command is a hand gesture.

19. The communication device of claim 18, wherein the hand gesture interrupts a light beam from the micro-display communication device and a pattern of interruptions to the light beam matches a pre-programmed pattern.

20. A wireless, micro-display communication system, comprising:
a mobile device transmitting displayable information; and
a micro-display communication device,
receiving the displayable information from a mobile device, the displayable information being related to an incoming call, an incoming multimedia message or a notification from an application;
detecting a proximate carrier for hosting a projection;
projecting the displayable information onto the proximate carrier;
receiving, by the micro-display communication device, a command from a user, the command being in response to the displayable information on the proximate carrier, the command being an acceptance or a rejection;
transmitting, by the micro-display communication device, the command to the mobile device; and
when the command is the acceptance, transferring the incoming call, the multimedia message or the notification from the mobile device to the micro-display communication device;
wherein the micro-display communication device is a wearable device.
